(19) United States
(12) Patent Application Publication
(10) Pub. No.: US 2015/0026031 A1
(43) Pub. Date: Jan. 22, 2015

(54) Method of Negotiating Currency Exchanges

(71) Applicant: Joseph Eugene Mullin, III, New York, NY (US)

(72) Inventor: Joseph Eugene Mullin, III, New York, NY (US)

(21) Appl. No.: 14/334,479

(22) Filed: Jul. 17, 2014

Related U.S. Application Data
(60) Provisional application No. 61/847,270, filed on Jul. 17, 2013.

(51) Int. Cl. G06Q 40/04

(52) U.S. Cl. CPC G06Q 40/04
USPC 705/37

(57) ABSTRACT

A method of negotiating currency exchanges is provided as a means of allowing users to search for currency offers and negotiate exchange prices through a currency exchange network. The currency exchange network facilitates currency exchanges by serving as an intermediary that helps users find currency exchange offers near them, negotiate prices for the currency exchange, and rate users following the completion of the currency exchange transaction. The method permits users to search for available currency offers based on location parameters. Additionally, the method allows users to submit currency exchange offers viewable by all users of the network or by select group of trusted users. Furthermore, the method permits users to transfer existing contact groups from partenered social networks to populate their list of trusted contacts.

The current application claims a priority to the U.S. Provisional Patent application Ser. No. 61/847,270 filed on Jul. 17, 2013.

### FIELD OF THE INVENTION

The present invention relates generally to a mobile application/computer networked platform for connecting users who want to exchange Currencies (in this instance “Currencies” are understood to be cash, legal tender, notes, foreign Currencies, coins, precious metals, or other stores of value such as Bitcoin or other virtual Currencies) directly and typically (though not exclusively) physical Currency in person with each other while minimizing the charges and fees incurred by utilizing more traditional Currency exchange options.

### BACKGROUND OF THE INVENTION

The foreign exchange services currently available make their profits by applying numerous charges and fees to parties wishing to exchange one Currency for another. These fees, depending on the service, can exceed 15% above the mid market rate, and further increasing the cost is the fact that fees are incurred at both ends of an exchange. For example, if one person exchanges dollars for euros, and another person exchanges euros for dollars, both are charged with fees, even though they've effectively created a single transaction. This further adds to the costs for the average person.

To bypass traditional exchange options, some services have been developed to mainly account to account exchanges. These services provide an improvement as they lower the cost for both parties involved in an exchange by avoiding the charges incurred with an exchange bureau, bank or other intermediary. However, these services still have some drawbacks, one of which is that transactions are almost entirely electronic; those wishing to obtain physical Currencies will still have to resort to using an exchange bureau, ATM, or other fee incurring service. This invention addresses the handling and listing of physical and other Currencies.

To address these issues the present invention allows users to list Currencies, such as those left over from a trip, in a virtual wallet. This virtual wallet can be shared over a network, through which other users can also post their Currency needs for upcoming trips. The network allows users looking to exchange the same type of Currencies to see if they want to trade with each other, agree on terms and physically (or virtually) meet up or arrange for a transfer. Thus, with the aid of an integrated calculator, the present invention allows users to directly exchange physical Currencies with one another. Therefore, the present invention reduces the pain of dealing with exchange bureaus as it provides a user friendly design in addition to creating monetary savings without hidden fees or misleading rates.

### BRIEF DESCRIPTIONS OF THE DRAWINGS

FIG. 1 is a flow chart diagram displaying a general process overview of the method of negotiating currency exchange as per the current embodiment of the present invention.

FIG. 2 is a flow chart diagram displaying the steps of creating a new user account for inclusion into a user base of the currency exchange network as per the current embodiment of the present invention.

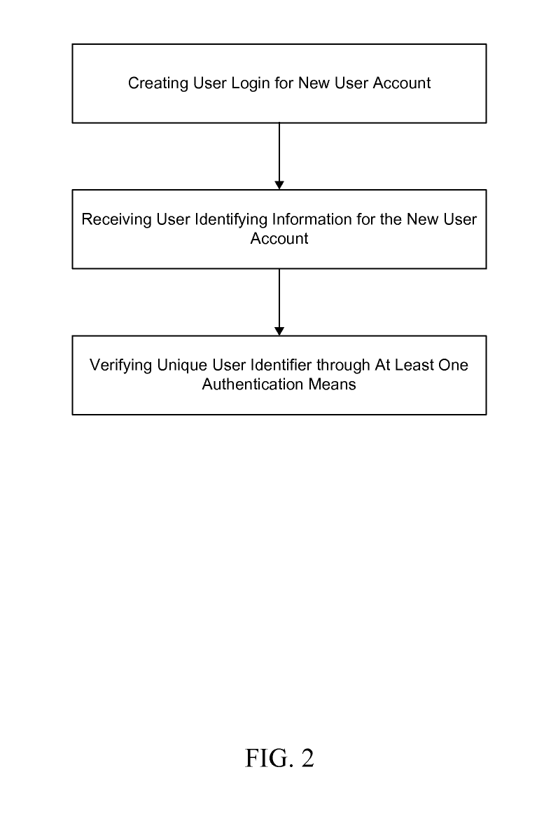

FIG. 3 is a flow chart diagram displaying the steps of associating user account with contact groups of a particular user account as per the current embodiment of the present invention.

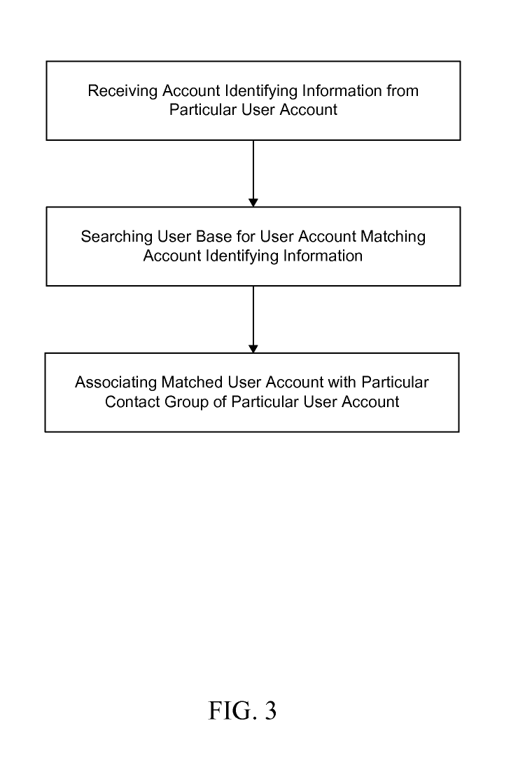

FIG. 4 is a flow chart diagram displaying the steps of restricting visibility of a particular user account as per the current embodiment of the present invention.

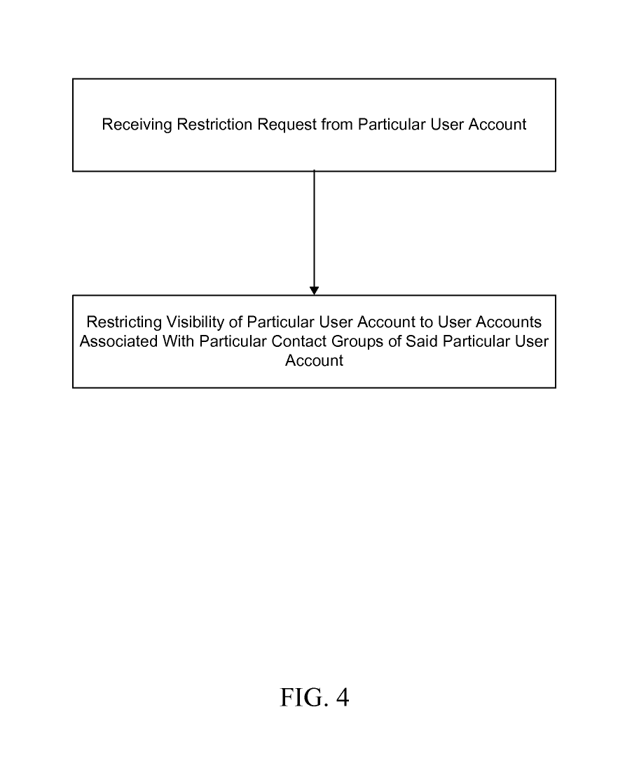

FIG. 5 is a flow chart diagram displaying the steps of generating exchange offers for a particular user account as per the current embodiment of the present invention.

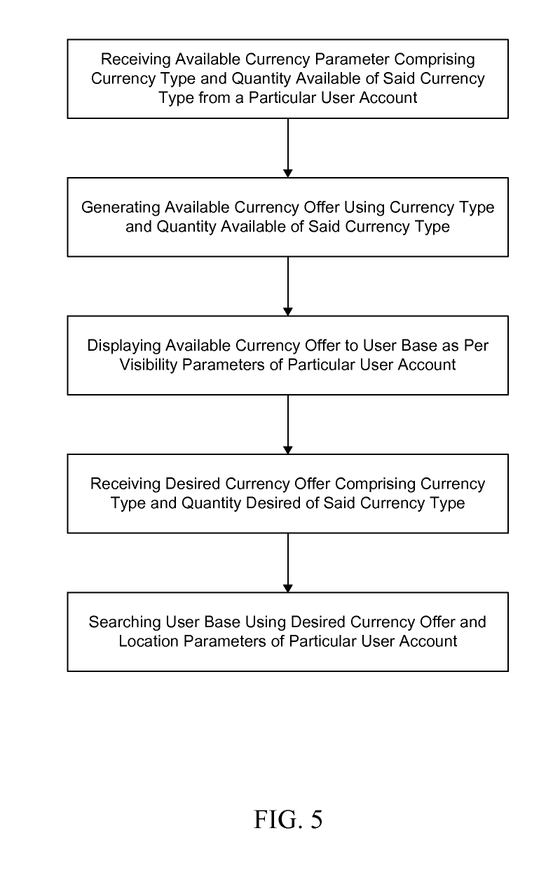

FIG. 6 is a flow chart diagram displaying the steps of matching exchange offers based on various parameters associated with a particular user account as per the current embodiment of the present invention.

FIG. 7 is a graphical representation of the search area for finding available user account with the search range being determined by distance from the starting location.

FIG. 8 is a graphical representation of the search area for finding available user accounts with the search range being determined by travel time from the starting location.

FIG. 9 is a flow chart diagram displaying the steps of handling communications between user accounts with matched exchange offers as per the current embodiment of the present invention.

### DETAIL DESCRIPTIONS OF THE INVENTION

All illustrations of the drawings are for the purpose of describing selected versions of the present invention and are not intended to limit the scope of the present invention.

The present invention is a method of negotiating currency exchanges between a community of users on a network. The method facilitates currency exchanges by serving as an intermediary that helps users find currency exchange offers near them, negotiate prices for the currency exchange, and rate users following the completion of the currency exchange transaction. The method permits users to search for available currency offers based on location parameters. Additionally, the method allows users to submit currency exchange offers viewable by all users of the network or by select group of trusted users.

In the current embodiment of the present invention, the method of negotiating currency exchanges is provided with a currency exchange network. The currency exchange network is a computerized network that receives user interactions through a mobile application or through a networked computer. The currency exchange network is provided with various capabilities allowing it to authenticate user accounts, detect user locations, receive and store information, search and identify information, make calculations, and transmit communications between users. It should be noted that the capabilities of the currency exchanged network can be accomplished through a plurality of means found in, but not necessarily limiting to, existing computerized systems.

In the current embodiment of the present invention, the currency exchange network comprises a user base. The user base comprises a plurality of user accounts that take part in the currency exchange network. Each user account of the plurality of user accounts is able to submit and search for currency exchange offers, adjust visibility of their submitted offers, limit searches of exchange offers based on currency and location, and communicated with other user accounts through the currency exchange network.

In the current embodiment of the present invention, the method of negotiating physical currency exchanges comprises the steps of creating a user account for inclusion into the user base, associating user accounts with contact groups of a particular user account, receiving location parameters from a particular user account, generating a exchange offers for a particular user account, determining matching exchange offers within the location parameters of the at least two user accounts, and handling the communication between the at least two user account with matching exchange offers.

The step of creating a new user account for inclusion into the user base is provided as a means of populating the user base with verified users. The step incorporates authentication means in the creation of a new user account in order to ensure the identity of user creating the user account. The step additionally provides users with a means of accessing their user account from different devices through an account login process. In the current embodiment of the present invention, the step of creating a new user account comprises the steps of creating a user login for a new user account, receiving user identifying information for the new user account, and verifying the user identifying information through at least one authentication means. The step of creating a user login restricts access of the user account to the user who created the account. The user identifying information that is received contains information such as a user's name, their email address, and additional contact information. The additional contact information and the email address can be used as a unique user identifiers in order to verify the identity of the user creating the new user account. The unique user identifiers allow the network to implement an authentication means. The verification of the user identifying information is accomplished by at least one authentication means. It should be noted that an authentication means can be accomplished by sending a confirmation code to a user via an email address of through their telephone. It should be noted that a new user account can be created by login in with a partnered social networks, login credentials. The partnered social network would have the ability to share information with the currency exchange network, typically through an application programming interface (API). The partnered social network may provide access to the user's unique user identifier as a source for contact information. The partnered social network can additionally provide access the user's existing contact groups on the social network as a means of populating the particular user accounts contact groups.

The step of associating user accounts with contact groups of a particular user account is provided as a means of differentiating user accounts. The step allows a particular user account to create associations and groups with user accounts, based on their identifying information in order to facilitate the implementation of privacy settings. The step of associating user accounts with contact groups comprises the steps of receiving account identifying information from a particular user account, searching the user base for a user account matching the account identifying information, and associating the matched use account with a contact group. The account identifying information submitted by the particular user account can be a user's name or email address as well as any means of uniquely identifying a user accounts in the user base. The account identifying information is used by the network to run a comparison search through the user base. The comparison search will yield results with user accounts containing information that matches the account identifying information. It should be noted that the user identifying information could be used to match that account identifying information. Upon identifying a matches user accounts, the particular user account is able to assign the matched user account to a particular contact group. It should be understood that contact groups differentiates a select group of user accounts and thus could be used to allow or completely deny a user account from all interactions with the particular user account based solely on association with a contact group.

In an embodiment of the invention, the account identifying information originates from existing contact groups from a partnered social network. In this embodiment, the partnered social network contains contact group (e.g. family, friends, coworkers, etc) with account identifying information that can be used to populate the particular user accounts contact groups. The currency exchange network would receive social network relationship parameters containing the account identifying information derived from the existing contact groups on the user's social network account. The account indentifying information would be used to determine shared user account between the currency exchange network and the partnered social network. It should be noted that contact group association from the partnered social network could be transferable to the contact groups on the currency exchange network for the particular user account.

The step of setting visibility parameters for contact groups is provided as a means of limiting visibility of the particular user account and its currency exchange offers based on association with a contact group. Linked user accounts and unlinked user accounts are provided as a general classification for user accounts in the user base, where linked user accounts are user accounts that have been associated with a contact group of the particular user account, while unlinked user accounts carry no association with any contact group of the particular user account. The step of setting visibility comprises the step of receiving a restriction request from the particular use account and restricting visibility of the particular user account based on the restriction request. The Restriction request contains parameters for restricting visibility of the particular user account but could be limited to just aspect of the particular user account such as information associated with currency exchange offers. The restriction request limits visibility of the particular user account to user accounts associated with particular contact groups of the particular user account. The aforementioned step provides the particular user account with an exclude all option based on the particular contact groups that would make the particular user account unavailable to unlinked accounts and linked accounts not associated with the particular contact groups.

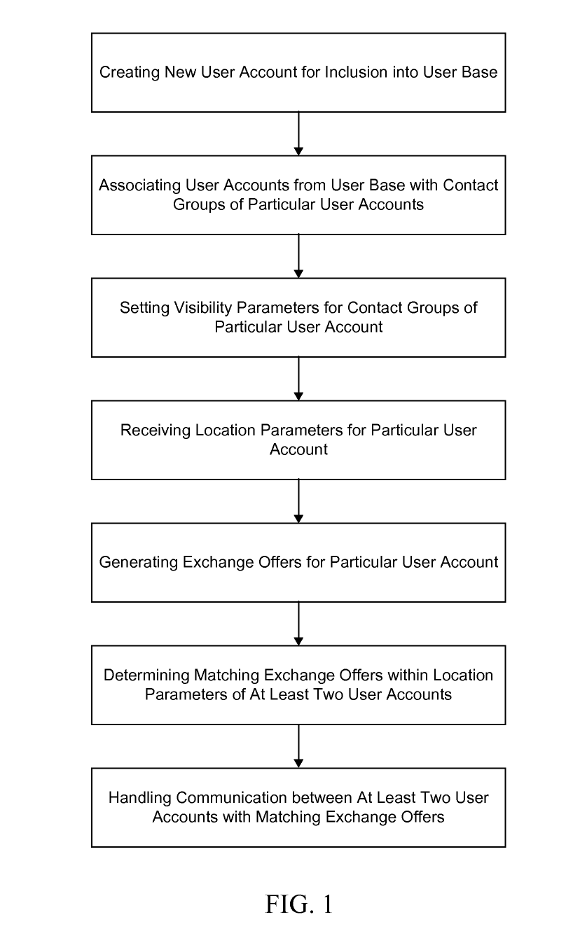

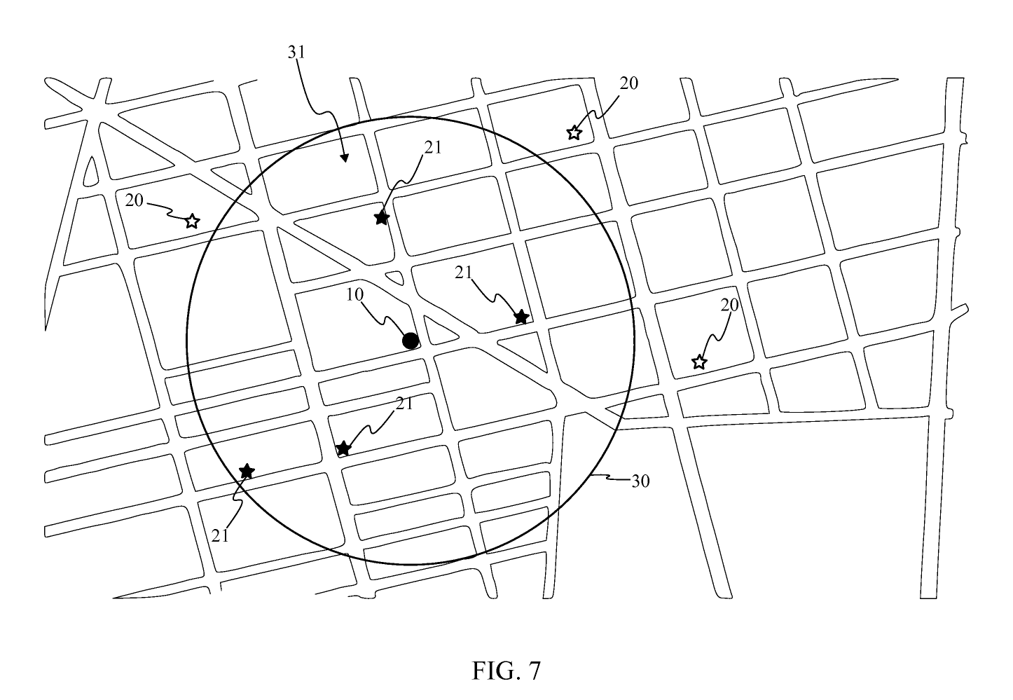

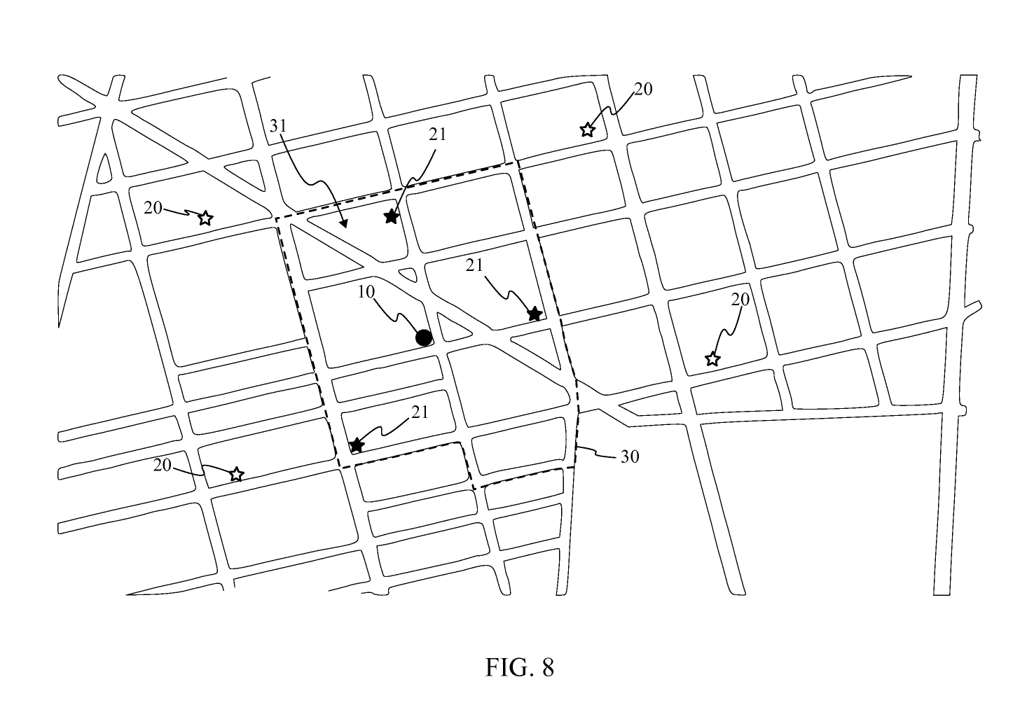

Referencing FIG. 1, FIG. 7, and FIG. 8, the step of receiving location parameters is provided as a means of setting a physical location for a particular user account in order to facilitate searching within a search range 30. Location parameters are received from each user account and contain a starting location 10 and a search range 30. The starting location 10 is a physical location that is the current approximate location of the user of the particular user account or a set location defined by the particular user account. The starting location 10 is used as the origin for the search range 30 when the particular user account conducts a search for available user account 21 with currency exchange offers. The starting location 10 is additionally utilized by other user accounts 20 conducting searches to determine if the particular user account is within their search range 30. It should be noted that the set location of a user account can be a temporary location. The search range 30 is the parameter by which a search area 31 is defined. The search range 30 defines a maximum value to which a user is willing to search for currency exchange offers. The search range 30 for a particular user account is based from the starting location 10. The search range 30 can be measured by either the distance travelled or by the time required to travel. With travel distance defining the search range 30, the network would populate search results based on radial distance from the starting point. With travel time defining the search range 30, the network would require the user to input a means of transportation and then calculate an average travel time based on the means of transportation.

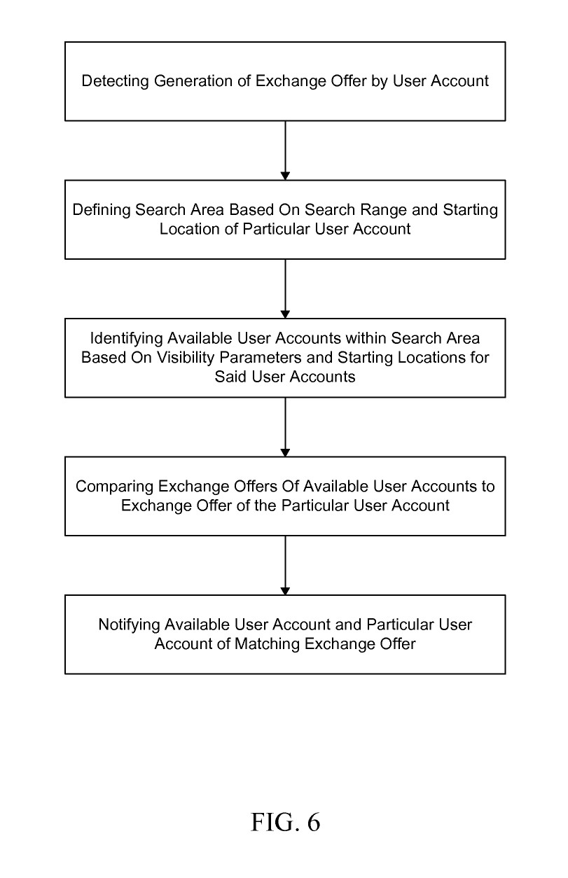

Referencing FIG. 1 and FIG. 6, the step of generating exchange offers is provided as a mean of searching for currency and making currency available for exchange with other user accounts. The step of generating exchange offers receives available currency parameters and a desired currency parameters from the particular user account. The available currency parameters comprise a currency type and quantity of said currency type that a particular user account has available for exchange with other user accounts. The currency type is the particular currency that a user has in their possession the quantity of the currency is the total amount available of said currency. It should be noted that the available currency parameters can additionally provide information regarding denomination of said currency type. The desired currency parameters comprise a currency type and the quantity of the said currency type being sought by the particular user account from other user accounts within their vicinity. The information received from the available currency parameters and the desired currency parameters are utilized to generate an available currency offer and a desired currency offer.

Referencing FIG. 6, the currency exchange network generates an available currency offers utilizing the currency type and the quantity of said currency type available. The available currency offer is viewable to user account on the user base according to the visibility parameters of the particular user account. It should be noted that while the current embodiment of the present invention provides the available currency offer as a posted listing, searchable by user account of the user base, in alternative embodiments the available currency offer could be used as a search parameters to find desired currency offers listed by nearby user accounts.

Referencing FIG. 6, the currency exchange network generates a desired currency offer utilizing the currency type and the quantity of said currency type desired. The desired currency offer is used to search the user base for user accounts offer the desired currency type and the quantity of said desired currency type. The currency exchange network additionally utilizes the location parameters of the particular user account to return user accounts 21 located within the search area 31. It should be noted that while in the current embodiment of the present invention provides the desired currency offer as part of a search function, additional embodiments can allow the desired currency offer to function as a posted listing which could be searchable by entering available currency parameters.

Referencing FIG. 6, FIG. 7, and FIG. 8, the step of determining a matching exchange offer enables user accounts to coordinate a physical currency exchange. The determination of matching exchange offers utilizes the visibility parameters and the location parameters of the particular user accounts to narrow results. After narrowing results, the currency exchange network compares the available currency exchange offers to the desired currency exchange offers and matches offers based on the currency type and the quantity of said currency type. In the current embodiment of the present invention, the determining matching exchange offers comprises the steps of detecting the generation of an exchange offer by a particular user account, defining a search area 31 for the particular user account, identifying available user account 21 within the search area 31, comparing exchange offers, and notifying available users accounts and the particular user account of the matching exchange offer.

The step of determining generation of an exchange offer by a particular user account is provided as the initiation step for determining a match. The network system determines that a particular user account has generated an exchange offer by receiving search request in the form of the desired currency offer. It should be noted that while the current embodiment of the present invention detects the generation of the exchange offer with the submission of the desired currency offer, that additional embodiment would allow the submission and displaying of an available currency offer to the user base as the initiation step.

Referencing FIG. 7, and FIG. 8, the step of defining a search area 31 narrows the search field based on the particular user's location parameters. The search area 31 is calculated using the particular user accounts starting location 10 as the origin and then using the maximum values defined by the search range 30 to define a search area 31. It should be noted that the aforementioned step is well suited for limiting an active search request generated by receiving a desired currency offer but could additionally be used to determine exclusions for user accounts whose search areas 31 do not overlap with their starting locations 10.

Referencing FIG. 6, FIG. 7, and FIG. 8, the step of identifying available user account 21 within the search area 31 is based on the starting location 10 and visibility parameters of said user accounts 20. With the search area 31 defined, the currency exchange network is able to narrow user accounts 20 by travel distance or time between the particular user accounts starting location 10 and the potential user account's 20 starting location 10. The currency exchange network further narrows results by determining if potential user accounts 20, within the search area 31, are visible to the particular user account. The currency exchange network accomplishes this determination by viewing the visibility parameters of the potential user accounts 20 and determining if the particular user account is allowed.

The step of comparing exchange offers of available user account 21 to the exchange offer of a particular user account determines matching exchange offers based on the currency type and the quantity of said currency type. In the current embodiment of the present invention, the currency exchange network searches through the available user account 21 for available currency offers that match the desired currency offer of the particular user account.

Referencing FIG. 6, the step of notifying the available user account and the particular user account of a matching exchange offer occurs after the identification of the available user account 21 and the determination of matching exchange offers between said available user account 21 and the particular user account. The notification step occurs when parameters for both steps are met without conflict. The notification step functions as an initiating step for communication handling step.

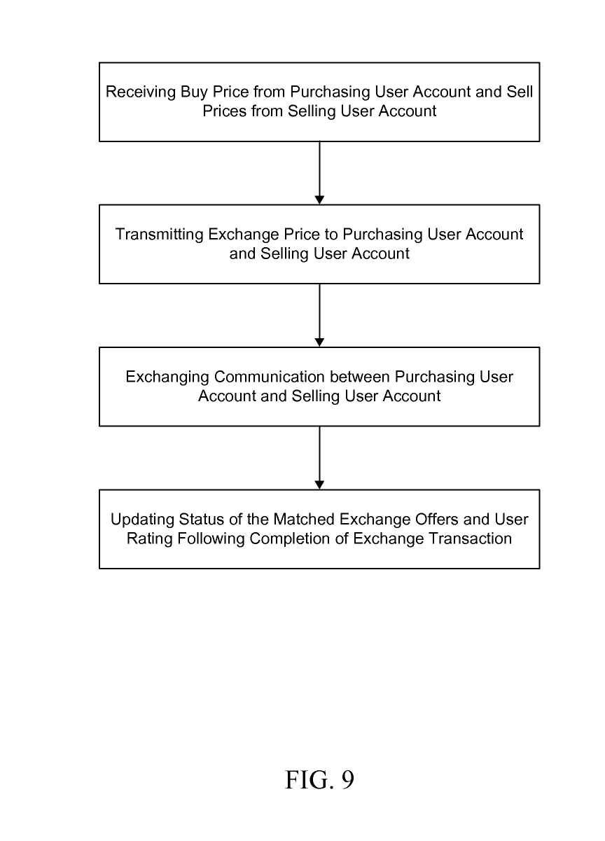

Referencing FIG. 9, the step of handling communications between user accounts with matching exchange offers provides users with a secure way of negotiating exchange prices for the currency as well as setting up a meeting time for the physical exchange of currency. The aforementioned step defines the at least two user accounts comprising a purchasing user account and a selling user account. The purchasing user account is the user account that submitted the desired currency offer while the selling user account is the user account that posted the available currency offer. After sending the notifications, alerting the user accounts of matching exchange offers, the currency exchange network receives a buy price from the purchasing user account and a sell prices from the selling user account. The buy price and the sell price is the transaction cost associated with the exchange of the currency between both user accounts. In an embodiment of the present invention, the currency exchange network includes a calculator function that generates an exchange price from the midpoint value between the buy price and the sell price. The calculator function is provides a mediated price for the purchasing user account and the selling user account. After an exchange price is transmitted to both user accounts, the currency exchange network exchanges communications as needed between the user accounts facilitating any additional arrangement for the physical currency exchange. Upon successfully completing a physical currency exchange, the currency exchange network would remove the desired currency exchange offer and would adjust the quantity of the currency available for the available currency exchange offer as needed. In an embodiment of the invention, social media features such as rating user experience can be included as a means of differentiating user accounts based on ratings.

The invention is a system designed to facilitate Currency exchange transactions (especially “Foreign Exchange,” “Forex” or “FX”) between a community of consumers, implemented as a mobile application (“App”) or on a networked computer. The invention provides several advantages as it enables direct exchange between consumers, and in particular physical or virtual exchanges of Currencies. This eliminates many exchange fees, and provides a means to connect consumers who are looking to buy and sell the same type of Currency.

The invention connects users through a network. Using this network allows users to carry out several functions. Users may indicate that they are looking to purchase or sell foreign Currency, use a map function to find other users in a local geographic area, use a Global Positioning System (“GPS”) to indicate their location and find other users, control who may see their postings, and use an integrated calculator feature to determine the mid market exchange rate for a transaction. Additionally, the calculator feature shows users how much money they are saving by avoiding the fees of traditional foreign exchange services; this is achieved, but using the Buy and Sell prices at a traditional Exchange bureau, these values allow the user through the App to calculate the implied mid market rate, and the spread between the Buy and Sell and the spread off of the mid-market rate.

Utilizing the invention requires that a consumer create an account with the company providing the service. Account creation is used to record data about the user, necessary for other functions of the invention, as well as verify the identity of the user. This latter process is implemented as a preventative measure against misuse and to increase security for users. The account creation process can be linked to a third party social networking site, allowing users to log in using their preferred social network account. Additional features to verify identity may be added. After creating their account a user may enter and later update several fields of information, including a list of friends and family as well as the user's physical location. By providing a list of friends and family (which can also be referred to as a “trusted network”) the user has the option of hiding their information from the general public; this is beneficial for users who do not wish to exchange Currencies with strangers. A user can set different privacy settings for different information. A user may: A. choose to hide the information in their wallet, they may B. only share it with their Trusted Network, they may C. only share the types of currencies but not the amounts with the broader network, or they may D. share all their wallet information (currencies and amounts) with the broader network. If a user is logging in via a social network account then the invention could allow the user to import a list of friends and family, expediting the setup process.

The physical location may include a primary location and other multiple locations, such as a home location, a work location, or temporary locations determined by GPS. The main purpose of the primary location is to set the “home Currency” that various Currencies are converted to. It is worth noting that the GPS location provides an approximate but not exact location for user security reasons.

The user's physical location is a determinant in how far they are willing to go to look for someone to exchange currency with, and the user's social network is an additional determinant in which users are comfortable exchanging with other users. The invention connects users by searching within the preset radius, or an area of a map for matching requests. Users are able to set which Currency they are looking to purchase, as well as which Currency they are looking to sell. User's can search or Currencies or receive alerts based on Currencies in their wallets. The system will then notify a first user, through an alert system, when a matching user is within a predefined radius, wherein the matching user is looking to purchase the Currency the first user is selling by paying with the Currency the first user is looking to obtain. For example, if the first user is looking to sell euros in exchange for dollars, the system will alert them when detecting a matching user, e.g. someone looking to sell dollars in exchange for euros. The first user will then be able to communicate with the matched user (or users, if more than one user matches the search criteria) in order to set up an exchange. To assist with the Currency exchange, the invention provides the calculator. Provided a buy price and a sell price, the calculator can determine the implied midpoint and the spread between aforementioned buy and sell price. In addition to providing the implied midpoint and spread, the invention will also include a system for comparing the cost of the transaction to the theoretical costs of an exchange carried out with a bank (which would incur costs of between 10 and 15 percent of the transaction), a bank (transaction costs ranging from 5 to 8 percent), and an ATM (transactions costs between 2 and 5 percent). The system will show costs associated with traditional methods of exchange and the implied savings of exchanging directly. As an example, to exchange one hundred US Dollars into Euros with a traditional service would typically be done at a rate of around 12.5% off the midpoint and incur a fee of around ten US Dollars this means a fees to the buyer of Euros of about $22.50. The same fees and spread are charged to the person selling Euros and buying US Dollars. So, the saving between the buyer and seller of 100 US Dollars worth of Euros would be about $45 in this scenario.

After users have agreed to and carried out a transaction, they may provide feedback regarding each other. The feedback helps users create a trustworthy reputation, encouraging users to make exchanges with other highly ranked users. Conversely, if a user receives a significant amount of negative feedback other users can use this feedback as a factor when considering whether to make an exchange with the negatively ranked user. The implementation of feedback serves as a secondary means in providing a safe and trustworthy system for users to make exchanges, with the primary means being the identity confirmation step in the account creation process.

The interface of the invention can be implemented in a variety of designs as long as they provide the described components of the invention. Future embodiments of the invention can integrate financial payment platforms, transfers and credit scoring, allowing the invention to also host financial transactions. Such additions may result in further complexity around compliance and security.

Although the invention has been explained in relation to its preferred embodiment, it is to be understood that many other possible modifications and variations can be made without departing from the spirit and scope of the invention as hereinafter claimed.

What is claimed is:

1. A method of negotiating physical currency exchange comprises the step of:
providing a currency exchange network comprising a user base, wherein the user base comprises a plurality of user accounts;
creating a new user account for inclusion into the user base;
associating user accounts, from the plurality of user accounts, with contact groups of particular user accounts;
setting visibility parameters for contact groups of a particular user account;
receiving location parameters for a particular user account, wherein the location parameters comprise a starting location and a search range;
generating exchange offers for a particular user account, wherein exchange offers comprise an available currency offer and a desired currency offer;
determining matching exchange offers within the location parameters of at least two user accounts; and
handling communication between the at least two user accounts with matching exchange offers.

2. The step of creating the new user account as claimed in claim 1 comprises the steps of:
creating a user login for a new user account;
receiving user identifying information for the new user account, wherein user identifying information comprises a unique user identifier; and
verifying the unique user identifier through at least one authentication means, wherein the unique user identifier is used to confirm additional information.

3. The step of associating user accounts with contact groups as claimed in claim 1 comprises the steps of:
receiving account identifying information from a particular user account;
searching the user base for a user account with matching account identifying information; and
associating matched user account with a particular contact group of the particular user account.

4. The step of receiving account identifying information as claimed in claim 3 comprises the steps of:
receiving social network relationship parameters, from an external source, for the particular user account, wherein social network relationship parameters comprise account identifying information associated with the particular user account's existing social network profile.

5. The step of setting visibility parameters for the contact group as claimed in claim 1 comprises the steps of:
providing linked accounts and unlinked accounts, wherein linked accounts are user accounts carrying association with a contact group of a particular user account while unlinked accounts carry no association with contact groups of the particular user account;
receiving a restriction request from the particular user account; and
restricting visibility of the particular user account to user accounts associated with particular contact groups of said particular user account, wherein said particular user account would be unavailable to unlinked accounts and linked accounts not associated with the particular contact groups of said particular account.

6. The step of receiving location parameters as claimed in claim 1 comprises the steps of:
configuring a starting location for a particular user account, wherein the starting location is a current location or a set location; and
configuring a search range from the starting location of the particular user account, wherein the search range defines a search area from the starting point for finding other user accounts.

7. The step of configuring the starting location as claimed in claim 6, wherein the starting location is a set location that is temporary.

8. The step of configuring the search range as claimed in claim 6, wherein the search range is based on distance travelled.

9. The step of configuring the search range as claimed in claim 6 comprises the steps of:
providing the search range being based on time travelled;
configuring a means of transportation for the particular user account; and
calculating time traveled from the starting location based on the means of transportation.

10. The step of generating exchange offers as claimed in claim 1 comprises the steps of:
providing the user base as a searchable database;
receiving an available currency parameter comprising a currency type and quantity available of said currency type from a particular user account;
generating the available currency offer using the currency type and the quantity available of said currency type from the particular user account;
displaying the available currency offer to the user base as per the visibility parameters of the particular user account;
receiving a desired currency offer comprising a currency type and a quantity desired of said currency type from a particular user account; and
searching the user base using the desired currency offer and the location parameters of the particular user account.

11. The step of determining a matching exchange offer as claimed in claim 1 comprises the steps of:
detecting generation of an exchange offer by a particular user account;
defining a search area based on the search range and the starting location of the particular user account;
identifying available user accounts within the search area based on visibility parameters and starting locations for said user accounts;
comparing exchange offers of the available user accounts to the exchange offer of the particular user account, wherein currency type and quantity desired for a desired currency offer is compared to the currency type and quantity available for an available currency offer; and
notifying an available user account and the particular user account of a matching exchange offer.

12. The step of handling communications between user accounts as claimed in claim 1 comprises the steps of:
providing the at least two users comprise a purchasing user account and a selling user account;
receiving a buy price from the purchasing user account and a sell prices from the selling user account;
transmitting an exchange price to the purchasing user account and the selling user account;
exchanging communication between the purchasing user account and the selling user account; and
updating status of the matched exchange offers and user rating following completion of an exchange transaction.

13. The step of handling communication between user accounts as claimed in claim 12 comprises the step of:
calculating an exchange price from the midpoint value of the buy price and the sell price.

14. A method of negotiating physical currency exchange comprises the step of:
providing a currency exchange network comprising a user base, wherein the user base comprises a plurality of user accounts;
providing the user base as a searchable database;
providing linked accounts and unlinked accounts, wherein linked accounts are user accounts carrying association with a contact group of a particular user account while unlinked accounts carry no association with contact groups of the particular user account;
providing the at least two users comprise a purchasing user account and a selling user account;
creating a user login for a new user account;
receiving user identifying information for the new user account, wherein user identifying information comprises a unique user identifier;
verifying the unique user identifier through at least one authentication means, wherein the unique user identifier is used to confirm additional information;
receiving account identifying information from a particular user account;
searching the user base for a user account with matching account identifying information;
associating matched user account with a particular contact group of the particular user account;
receiving a restriction request from the particular user account; and
restricting visibility of the particular user account to user accounts associated with particular contact groups of said particular user account, wherein said particular user account would be unavailable to unlinked accounts and linked accounts not associated with the particular contact groups of said particular account;
configuring a starting location for a particular user account, wherein the starting location is a current location or a set location;
configuring a search range from the starting location of the particular user account, wherein the search range defines a search area from the starting point for finding other user accounts;
receiving an available currency parameter comprising a currency type and quantity available of said currency type from a particular user account;
generating the available currency offer using the currency type and the quantity available of said currency type from the particular user account;
displaying the available currency offer to the user base as per the visibility parameters of the particular user account;
receiving a desired currency offer comprising a currency type and a quantity desired from a particular user account;
searching the user base using the desired currency offer and the location parameters of the particular user account;
detecting generation of an exchange offer by a particular user account;
defining a search area based on the search range and the starting location of the particular user account;
identifying available user accounts within the search area based on visibility parameters and starting locations for said user accounts;
comparing exchange offers of the available user accounts to the exchange offer of the particular user account, wherein currency type and quantity desired for a desired currency offer is compared to the currency type and quantity available for an available currency offer;
notifying an available user account and the particular user account of a matching exchange offer;
receiving a buy price from the purchasing user account and a sell prices from the selling user account;
transmitting an exchange price to the purchasing user account and the selling user account;
exchanging communication between the purchasing user account and the selling user account; and
updating status of the matched exchange offers and user rating following completion of an exchange transaction.

15. The step of receiving account identifying information as claimed in claim 3 comprises the steps of:
receiving social network relationship parameters, from an external source, for the particular user account, wherein social network relationship parameters comprise account identifying information associated with the particular user account's existing social network account.

16. The step of configuring the starting location as claimed in claim 14, wherein the starting location is a set location that is temporary.

17. The step of configuring the search range as claimed in claim 14, wherein the search range is based on distance travelled.

18. The step of configuring the search range as claimed in claim 14 comprises the steps of:
providing the search range being based on time travelled;
configuring a means of transportation for the particular user account; and
calculating time traveled from the starting location based on the means of transportation.

19. The step of handling communication between user accounts as claimed in claim 14 comprises the step of:
calculating an exchange price from the midpoint value of the buy price and the sell price.
